(19) United States
(12) Patent Application Publication
(10) Pub. No.: US 2006/0103757 A1
(43) Pub. Date: May 18, 2006

(54) Iris apparatus and operating method thereof

(75) Inventors: James Lee, Taipei (TW); Chung-I Chiang, Taipei (TW)

Correspondence Address: LADAS & PARRY, 26 WEST 61ST STREET, NEW YORK, NY, 10023, US

(73) Assignee: NSMC HOLDINGS INTERNATIONAL CORP. LTD.

(21) Appl. No.: 10/989,157

(22) Filed: Nov. 15, 2004

(51) Int. Cl. H04N 5/235

(52) U.S. Cl. 348/362

(57) ABSTRACT

The present invention discloses an iris apparatus and an operation method thereof, which iris apparatus can be used in an electrical micro-optic module or compact camera module. The iris apparatus is composed of a shifting board comprising one or at least two apertures thereon. By moving the shifting board, a required aperture can be transported to correct location so as to pass through or filter a path of light.

### BACKGROUND OF THE INVENTION

(A) Field of the Invention

The present invention relates to an iris apparatus to adjust an aperture value and to add extra filters, in particular, to an iris apparatus for a compact camera module (CCM) or electrical micro-optic module.

(B) Description of Related Art

For ordinary cameras (including digital cameras), iris structures used in adjusting an aperture value are composed by a plurality of fin plates (usually 6), which are arranged in a circle so as to control the aperture value by centrifugal or centripetal movements of the plates. However, assembly of such a structure is complicated and light penetrating between plates is also a big problem of the prior art structure. According to aforementioned drawbacks of the prior art, many innovated iris (aperture) structures have been invented, such as TW 582,565, which is an iris structure based on LCD. By adjusting the color and pattern of the LCD, light entering the CCM (which means aperture and shutter) can be properly adjusted. However, not only the slow refresh rate of LCD makes it unqualified as a commercial shutter, LCD also consumes a significant portion of total power consumed in a digital camera, and apparently, adding another LCD is not a good idea.

The present invention presents an innovated structure for the iris structure in photograph systems, which solves the drawbacks of the prior art.

### SUMMARY OF THE INVENTION

The present invention relates to an iris apparatus in a photograph system and to an operation method thereof, which iris apparatus can be an add-on structure for an electrical micro-optic module, especially for CCM. The present invention uses preformed, non-adjustable apertures instead of adjustable fin plates so as to reduce complexity and movement inertia for power saving in portable devices. For instance, if the photography system comprises 5 different aperture values, 5 apertures in different sizes (or shapes) are preformed. Said apertures are located on a shifting board, and said board can be moved so that a desired aperture can be moved to the path of light so as to perform the function of aperture adjustment or filtering. Of course, due to the compactness of the present invention, more than one of the iris apparatus can be installed in one photographic system or one iris apparatus can comprises more than one shifting boards and the combination thereof can be useful. For example, if lateral size is limited by a certain “footprint” or lateral dimensions, then a design comprising more than one shifting board, wherein each board could have fewer number of apertures/filters than that of a single shifting board, will be applied so as to reduce the size within the footprint. All the shifting boards aforementioned will be placed in layers and the shifting boards are tiny enough to enclose them inside the limited dimension without protrusion during operation. An example mechanism of the structure is the week/date adjusting mechanism of a mechanical wristwatch. The display layers of “week” and “date” are different, and each layer can be adjusted through the same outer knob via hollow shaft.

Moreover, filters can be installed with the apertures for higher functionality. The size of the aperture (iris) together with the type of the filters (UV-cut, IR-cut, night vision, or photochromatic filters) can be interchanged or combined for optional requirement of photography. The movement of the aperture can be either manually by an exterior knob or motorized by gear-motor combination. For obtaining certain photographic effects, motorized movement is preferred for intelligent selection of filter-aperture combination. The present invention has the following advantages:
1. Simple to operate and mount with minimum height (Z-direction) increase;
2. The packaging of CCM will not be broken and the risk for breaking hermetic sealing and possible particle contamination are minimized;
3. Filters and iris exchanging mechanism can be combined in a single structure.

### BRIEF DESCRIPTION OF THE DRAWINGS

The present invention is described below by way of examples with reference to the accompanying drawings which will make it easier for readers to understand the purpose, technical contents, characteristics and achievement of the present invention, wherein

FIG. 1 is a cross-sectional view of the present invention installed in a photographic system;

FIG. 2 is an exploded view of the present invention.

### DETAILED DESCRIPTION OF THE INVENTION

The detailed description of the preferred embodiments respect to the appended figures is intended to describe the present invention, and is not intended to limit forms to embody the present invention.

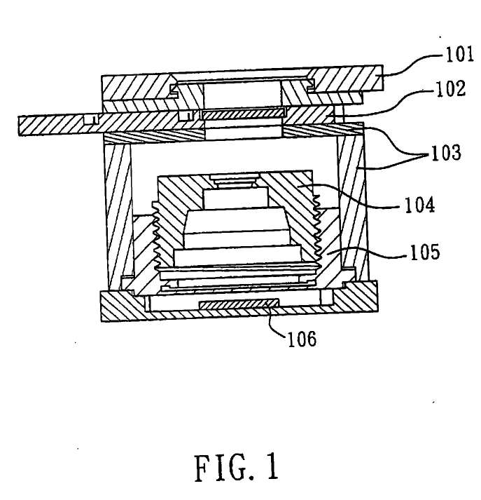

Please refer to FIG. 1, the embodiment according to the present invention is installed on a CCM. An ordinary CCM includes an image sensor 106 bonded on a substrate, a lens barrel 104 and a lens mount 105. The image sensor 106 is installed on the substrate and the lens mount 105 is also installed on the substrate, covering the image sensor 106. The lens barrel 104 is placed inside the lens mount 105 and the substrate, lens mount 105 and lens barrel 104 form a closed space containing the image sensor 106 within. The lens barrel 104 can move towards or away from the image sensor 106 so as to achieve the purpose of focusing. In FIG. 1, the CCM is covered by a packaging structure 103 comprising an entrance preserved for a path of light to enter the CCM and the iris structure is located thereon.

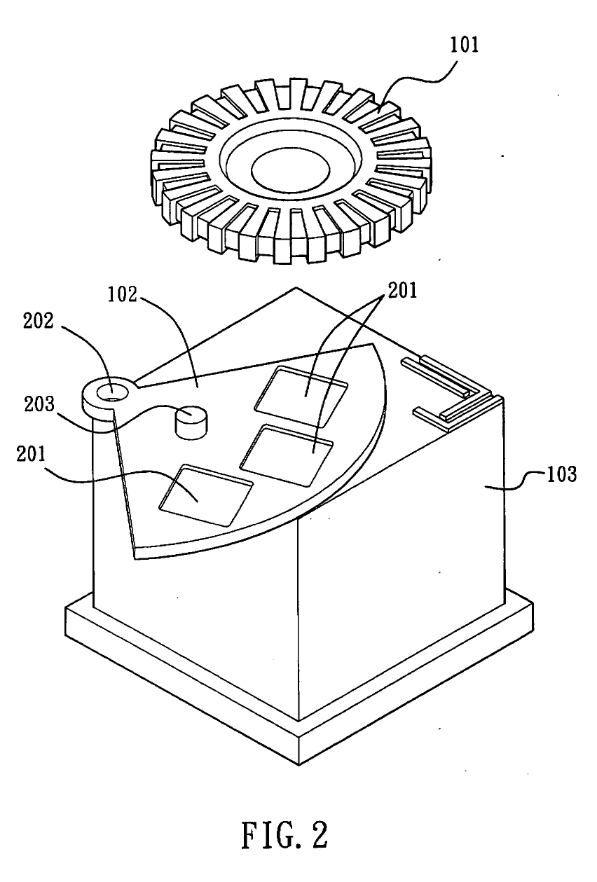

Please refer to FIG. 2, exterior plate 101 of the photographic system is removed for a clearer view to the iris apparatus. The embodiment according to present invention comprises a fan-shaped shifting board 102 and one or at least two apertures, such as three apertures 201 as provided in the embodiment are formed thereon in equal distance to the pivot 202 of the fan 102. The shifting board 102 pivots on the pivot 202. A path of light will pass through the exterior plate 101 first, then passing through one of the apertures 201, and into the CCM through said entrance. Each of the apertures 201 has a corresponding location for the fan-shaped shifting board 102. When an aperture value is required, the shifting board 102 will move to the location corresponding to said required aperture so as to make the required aperture located on the path of light. In the embodiment, just for instance and not meant to limit the scope of invention, pin 203 fixes on the shifting board 102 and slides in a trail (not shown in drawings) comprising a number of round pits as the shifting board moves. When the pin moves into one of the round pits, the shifting board will be “trapped” in that location and this determines one of the “stop locations” aforementioned.

1. An iris apparatus, provided between a light source and a container of a photographic system, comprising:
a shifting board, comprising one or at least two penetrating aperture thereon, said board and the one or at least two apertures being configured to let a path of light from the light source pass through a specified aperture of said at least two apertures and into said container when the board is moved to a predetermined location corresponding to the specified aperture.

2. The iris apparatus of claim 1, wherein said at least two penetrating apertures are in different sizes or shapes.

3. The iris apparatus of claim 1, wherein said one or at least two penetrating apertures can be covered or filled by filters.

4. The iris apparatus of claim 1, wherein said container is a CCM or electrical micro-optic module and has a fixed entrance for the path of light to enter the container.

5. The iris apparatus of claim 1, wherein the shifting board is in the shape of a flat plate and said one or at least two aperture penetrates the board in the thinnest direction.

6. The iris apparatus of claim 5, wherein the shifting board comprises a pivot mechanism and the board pivots on the pivot mechanism.

7. The iris apparatus of claim 5, further comprising one or at least two additional shifting board, each comprising one or at least two penetrating aperture thereon, said board and the one or at least two apertures being configured to let a path of light from the light source pass through a specified aperture of said at least two apertures and into said container when the board is moved to a predetermined location corresponding to the specified aperture.

8. The iris apparatus of claim 7, wherein each of the shifting board and the additional shifting board comprise a pivot mechanism and pivot on said pivot mechanism.

9. The iris apparatus of claim 8, wherein pivoting axes of the pivot mechanisms are all laid along a straight line or parallel to each other.

10. The iris apparatus of claim 6, wherein the apertures are located in equal distance to said pivot.

11. The iris apparatus of claim 8, wherein the apertures on the same shifting board are located in equal distance to the pivot of said the same shifting board.

12. A method for operating the iris apparatus as claimed in claim 1, comprising the steps:
adjusting an amount or quality of light entering the CCM by moving the shift board to one of the predetermined locations so that the specified aperture required can be located in the path of light.

13. The method of claim 12, wherein said shift board is moved by means of pivoting on a pivot mechanism.

14. A method for operating the iris apparatus as claimed in claim 5, comprising the steps:
adjusting an amount or quality of light entering the CCM by moving the shift board to one of the predetermined locations so that the specified aperture required can be located in the path of light.

15. The method of claim 14, wherein said shift board is moved by means of pivoting on a pivot mechanism.

16. A method for operating the iris apparatus as claimed in claim 7, comprising the steps:
adjusting an amount or quality of light entering the CCM by moving the shifting board and the additional shifting board to predetermined locations thereof so that the path of light from the light source can sequentially pass specified apertures on the shifting board and the additional shifting board, and then into the CCM.

17. The method of claim 16, wherein said shifting board and additional shifting board are moved by means of pivoting on a pivot mechanism.
